(19) United States
(12) Patent Application Publication
(10) Pub. No.: US 2026/0134433 A1
(43) Pub. Date: May 14, 2026

(54) METHOD AND SYSTEM FOR REDUCING A LIKELIHOOD OF A FRAUDULENT TRANSACTION

(71) Applicant: GRABTAXI HOLDINGS PTE. LTD., Singapore (SG)

(72) Inventors: Xue Fang NG, Singapore (SG); Duc Thien NGUYEN, Singapore (SG); Peixuan SUN, Singapore (SG); Jia CHEN, Singapore (SG)

(21) Appl. No.: 19/120,417

(22) PCT Filed: Sep. 12, 2023
(86) PCT No.: PCT/SG2023/050616

§ 371 Date: Apr. 11, 2025

(30) Foreign Application Priority Data
Oct. 20, 2022 (SG) 10202251443G

(51) Int. Cl. G06Q 20/40

(52) U.S. Cl. CPC G06Q 20/4016

(57) ABSTRACT

The present disclosure provides methods and systems for reducing a likelihood of a fraudulent transaction. In some examples, there is provided a method comprising: estimating, by a server, a profit that can be earned from a user over a period of time after each of allowing a transaction of the user and blocking the transaction of the user, the estimated profit being based on information relating to the user; determining, by the server, whether the transaction is a fraudulent transaction based on the estimated profit, and allowing or blocking the transaction based on the determination.

### FIELD OF INVENTION

The present disclosure relates broadly, but not exclusively, to methods and systems for reducing a likelihood of a fraudulent transaction.

### BACKGROUND

Platforms offering services such as ride-hailing services, delivery services, sale of merchandise, food, and other similar services typically have in place a fraud prevention system which usually consists of a series of human-defined rules or Machine Learning (ML) models that issue actions on users of a platform upon detection of suspicious behaviors. Professional fraudsters may use advanced technologies to abuse promotions offered by a platform at a larger scale, while some users simply try to game on promotions occasionally. Based on the degree of severity, different actions will be taken, such as promotion blocking, transaction blocking and account banning.

However, rules and models with manually defined thresholds suffer from poor adaptiveness to the environment. When the environment changes due to factors like pandemic, business competition and country regulation, user behaviors will change. Thus, static rules and models are likely to produce high false-positives (e.g., identify normal users as fraudsters) or false negatives (e.g., fail to detect fraudsters), which generates unnecessary friction for normal users or punishment measures that are too harsh for a minor fraud. Such poor user experience can result in high appeal rate, high user churn rate and eventually loss in revenue.

A need therefore exists to provide methods and systems that seek to overcome or at least minimize the above mentioned challenges.

### SUMMARY

According to a first aspect of the present disclosure, there is provided a method for reducing a likelihood of a fraudulent transaction, the method comprising: estimating, by a server, a profit that can be earned from a user over a period of time after each of allowing a transaction of the user and blocking the transaction of the user, the estimated profit being based on information relating to the user; determining, by the server, whether the transaction is a fraudulent transaction based on the estimated profit, and allowing or blocking the transaction based on the determination.

According to a second aspect of the present disclosure, there is provided a system for reducing a likelihood of a fraudulent transaction, comprising: at least one processor; and at least one memory including computer program code; the at least one memory and the computer program code configured to, with the at least one processor, cause the system at least to: estimate a profit that can be earned from a user over a period of time after each of allowing a transaction of the user and blocking the transaction of the user, the estimated profit being based on information relating to the user; determine whether the transaction is a fraudulent transaction based on the estimated profit, and allowing or blocking the transaction based on the determination.

### BRIEF DESCRIPTION OF THE DRAWINGS

Embodiments and implementations are provided by way of example only, and will be better understood and readily apparent to one of ordinary skill in the art from the following written description, read in conjunction with the drawings, in which:

FIG. 1 illustrates a system for reducing a likelihood of a fraudulent transaction according to various embodiments of the present disclosure.

FIG. 2 is a schematic diagram of an action server, according to various embodiments of the present disclosure.

FIG. 3 depicts an overview of Reinforcement Learning (RL) according to various embodiments.

FIG. 4 depicts an example illustration of how a likelihood of a fraudulent transaction may be reduced according to various embodiments.

FIG. 5 illustrates an example flow diagram for a method for reducing a likelihood of a fraudulent transaction according to various embodiments.

FIG. 6A is a schematic block diagram of a general purpose computer system upon which the action server of FIG. 2 can be practiced.

FIG. 6B is a schematic block diagram of a general purpose computer system upon which a combined transaction processing and action server of FIG. 1 can be practiced.

FIG. 7 shows an example of a computing device to realize the transaction processing server shown in FIG. 1.

FIG. 8 shows an example of a computing device to realize the action server shown in FIG. 1.

FIG. 9 shows an example of a computing device to realize a combined transaction processing and action server shown in FIG. 1.

Skilled artisans will appreciate that elements in the figures are illustrated for simplicity and clarity and have not necessarily been depicted to scale. For example, the dimensions of some of the elements in the illustrations, block diagrams or flowcharts may be exaggerated in respect to other elements to help to improve understanding of the present embodiments.

### DETAILED DESCRIPTION

### Terms Description

A platform refers to a set of technologies that is used as a base for facilitating exchanges between two or more interdependent servers, entities and/or devices, for example between a requestor device (of a product or service) and a provider device (of the product or service). For example, a platform may offer a service offered by a provider such as a ride, delivery, online shopping, insurance, and other similar services to a requestor. The requestor can typically access the platform via a website, an application, or other similar methods.

A platform may implement a fraud prevention system to detect suspicious behaviour such as attempts to abuse the platform. For example, a platform may at times offer promotions for its services such as discounts, membership perks, freebies and other similar promotions. Some users of the platform may abuse the promotion by, for example, setting up multiple accounts to take advantage of a promotion that is available once per user only, make one or more transactions and cancel them shortly after, or other similar acts. Such abusive actions may result in profit loss of the platform, slowdown in performance of the platform application due to a sudden temporary increase in number of users, or other similar outcomes. In response to such fraudulent acts, an action may be taken to deter and punish these users. For example, an action may be taken based on a determination of whether a transaction of a user is a fraudulent transaction, the action being one or more of allowing the transaction, blocking the transaction, blocking a promotion associated with the transaction, banning an account of the user, and other similar actions. Determining whether the transaction is fraudulent and which action to take may be based on an estimated profit earned from the user over a period of time after each action, and may be further based on historical data comprising a previously obtained information relating to the user, a previous determination of whether to allow or block a transaction of the user and a profit earned from the user over the period of time after the previous determination. The profit may be estimated based on information relating to the user (e.g., a user profile, a transaction history, a risk profile and a financial profile of the user).

Deep Reinforcement Learning (DRL) system refers to a self-learning system that reinforces its correct decisions and learns from the incorrect ones, by trying to maximize its observed reward post-action. The reward may be a profit earned from a user over a period of time after an action is taken in response to a transaction of the user (e.g., allow the transaction, block the transaction, block a promotion associated with the transaction, banning an account of the user, and other similar actions). Such a system adapts to changes in the environment through exploration, using for example an epsilon-greedy action selection, may be utilized to determine which action to take. Epsilon-greedy is a method to balance exploration and exploitation by choosing between exploration and exploitation randomly. Exploration allows an agent (e.g., a deep neural network) to improve its current knowledge about each action, hopefully leading to a long-term benefit. Improving the accuracy of the estimated profit enables an agent to make more informed decisions in the future. Exploitation, on the other hand, selects a ‘greedy’ action to get the most reward (e.g., taking an action having the highest estimated profit) by exploiting the agent's current action-value estimates. However, being greedy with respect to action-profit estimates may not actually get the most reward, and may lead to sub-optimal behaviour. When an agent explores, it gets more accurate estimates of action-values, and when it exploits, it may get more reward. It cannot, however, choose to do both simultaneously, which is also called the exploration-exploitation dilemma. The epsilon-greedy, where epsilon refers to a probability to randomly make a determination to take an action (e.g., allow a transaction of a user, block the transaction, block a promotion associated with the transaction, banning an account of the user, and other similar actions). This probability may be termed as an epsilon probability which may be set depending on application. Accordingly, determining whether a transaction is a fraudulent transaction may be further based on this probability e.g., a probability to randomly make a determination to allow or block the transaction. It will be appreciated that other actions besides allowing or blocking the transaction may also be included, such as blocking a promotion associated with the transaction, banning an account of the user, and other similar actions.

In at least some embodiments, a user may be any suitable type of entity, which may include a person, a consumer looking to purchase a product or service via a transaction processing server, a seller or merchant looking to sell a product or service via the transaction processing server, a motorcycle driver or pillion rider in a case of the user looking to book or provide a motorcycle ride via the transaction processing server, a car driver or passenger in a case of the user looking to book or provide a car ride via the transaction processing server, and other similar entity. A user who is registered to the transaction processing server will be called a registered user. A user who is not registered to the transaction processing server will be called a non-registered user. The term user will be used to collectively refer to both registered and non-registered users. A user may interchangeably be referred to as a requestor (e.g., a person who requests for a product or service) or a provider (e.g., a person who provides the requested product or service to the requestor).

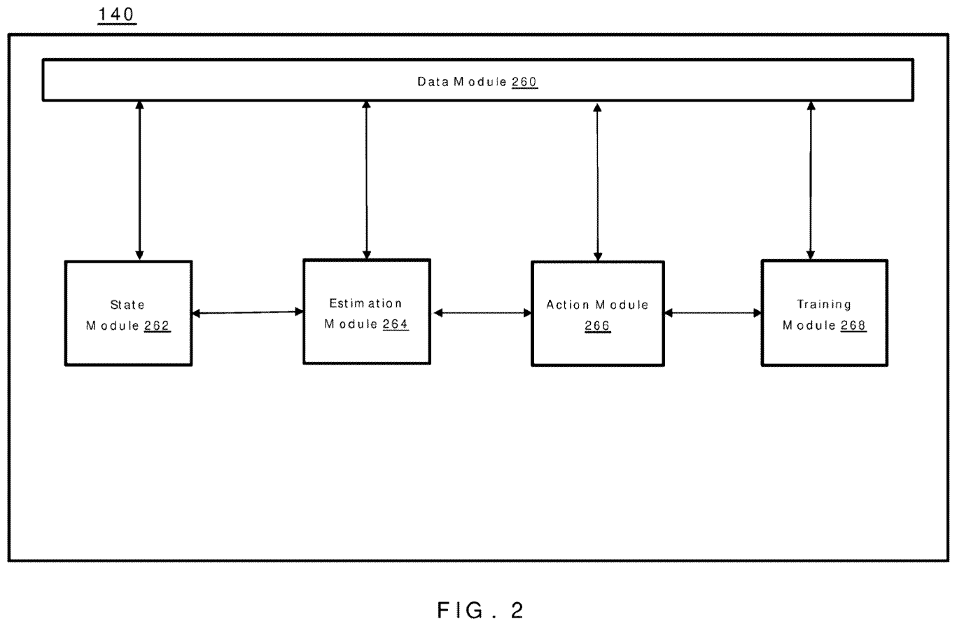

In at least some embodiments, an action server is a server that hosts software application programs for reducing a likelihood of a fraudulent transaction. The action server may be implemented as shown in the schematic diagram of FIG. 2 for reducing a likelihood of a fraudulent transaction.

In at least some embodiments, a transaction processing server is a server that hosts software application programs for processing payment transactions for, for example, a travel-ordination request, purchasing of a good or service by a user, and other similar services. The transaction processing server communicates with any other servers (e.g., an action server) concerning processing payment transactions relating to the purchasing of the good or service. For example, data relating to a payment transaction of a user (e.g., date, time, details of good or service to be purchased, and other similar data), information relating to the user (e.g., a user profile, a transaction history, a risk profile and a financial profile of the user), and other similar data may be provided to the action server and processed to reduce a likelihood of a fraudulent transaction. The transaction processing server may use a variety of different protocols and procedures in order to process the payment and/or travel co-ordination requests.

Transactions that may be performed via a transaction processing server include product or service purchases, credit purchases, debit transactions, fund transfers, account withdrawals, etc. Transaction processing servers may be configured to process transactions via cash-substitutes, which may include payment cards, letters of credit, checks, payment accounts, etc.

In at least some embodiments, the transaction processing server is usually managed by a service provider that may be an entity (e.g., a company or organization) which operates to process transaction requests and/or travel co-ordination requests. The transaction processing server may include one or more computing devices that are used for processing transaction requests and/or travel co-ordination requests.

In at least some embodiments, a transaction account is an account of a user who is registered at a transaction processing server. The user can be a customer, a merchant providing a product for sale on a platform and/or for onboarding the platform, a hail provider (e.g., a driver), or any third parties (e.g., a courier) who want to use the transaction processing server. In certain circumstances, the transaction account is not required to use the transaction processing server. A transaction account includes details (e.g., name, address, vehicle, face image, etc.) of a user. The transaction processing server manages the transaction.

Embodiments will be described, by way of example only, with reference to the drawings. Like reference numerals and characters in the drawings refer to like elements or equivalents.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “estimating”, “taking”, “extracting”, “assessing”, “determining”, “associating”, “selecting”, “calculating”, “processing”, “storing”, “indicating”, “discerning”, or the like, refer to the action and processes of a computer system, or similar electronic device, that manipulates and transforms data represented as physical quantities within the computer system into other data similarly represented as physical quantities within the computer system or other information storage, transmission or display devices.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the scope of the specification.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on such a computer effectively results in an apparatus that implements the steps of the preferred method.

In typical fraud protection systems, resources required to manage and keep hundreds of rules and models updated is huge, and many of the rules are defined based on human experience, making it difficult to maintain and update. There is a need to provide a system that can automatically adapt to changes in the environment while quantitatively optimizing for minimal user friction and fraud loss (e.g., profit loss as a result of the fraudulent acts).

In the present disclosure, a solution is presented that utilizes deep reinforcement learning (DRL) to make personalized decisions on the actions to be taken on various types of users. It is a self-learning system that reinforces its correct decisions and learns from the incorrect ones, by trying to maximize its observed reward post-action. The system adapts to the changes in the environment through exploration, using epsilon-greedy action selection. The reward can be any business metrics that can be optimized for, for example the profit of all users checked by the fraud prevention system (profit=revenue−cost−fraud loss).

An advantage of the proposed DRL system compared to traditional rule-based and ML model based systems is that the DRL system is auto-adaptive to the environment. It is advantageously able to choose to explore the unknown outcomes (e.g., outcomes of actions not having a high estimated value) and discovers changes in the environment by giving random actions with epsilon probability. Furthermore, the system uses quantitatively measurable metrics (e.g., profit earned from a user over a period of time after an action) as a reward for the agent to maximize for, and it does not require any manually chosen threshold that may be subjective.

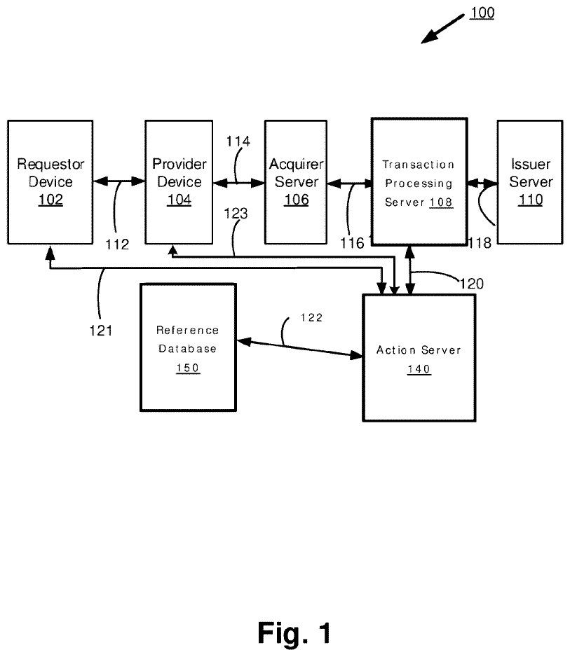

FIG. 1 illustrates a block diagram of an example system 100 for reducing a likelihood of a fraudulent transaction. In some embodiments, the system 100 enables a transaction for a good or service, and/or a request for a ride or delivery of a physical item (e.g., one or more food items or a parcel) between a requestor and a provider.

The system 100 comprises a requestor device 102, a provider device 104, an acquirer server 106, a transaction processing server 108, an issuer server 110, an action server 140 and a reference database 150.

The requestor device 102 is in communication with a provider device 104 via a connection 112, and may be associated with a user. The connection 112 may be wireless (e.g., via NFC communication, Bluetooth, etc.) or over a network (e.g., the Internet). The requestor device 102 is also in communication with the action server 140 via a connection 121, wherein the action server 140 may be configured to receive information relating to a user (e.g., a user profile, a transaction history, a risk profile and a financial profile of the user) from the requestor device 102. The connection 121 may be via a network (e.g., the Internet). The requestor device 102 may also be connected to a cloud that facilitates the system 100 for reducing a likelihood of a fraudulent transaction. For example, the requestor device 102 can send a signal or data to the cloud directly via a wireless connection (e.g., via NFC communication, Bluetooth, etc.) or over a network (e.g., the Internet).

The provider device 104 is in communication with the requestor device 102 as described above, usually via the transaction processing server 108, and may also be associated with a user. The provider device 104 is, in turn, in communication with an acquirer server 106 via a connection 114. The provider device 104 is also in communication with the action server 140 via a connection 123, wherein the action server 140 may be configured to receive data relating to a transaction of a user (e.g., date, time, details of good or service to be purchased, and other similar data) and information relating to the user (e.g., a user profile, a transaction history, a risk profile and a financial profile of the user) from the provider device 104. The connections 114 and 123 may be via a network (e.g., the Internet). The provider device 104 may also be connected to a cloud that facilitates the system 100 for reducing a likelihood of a fraudulent transaction. For example, the provider device 104 can send a signal or data to the cloud directly via a wireless connection (e.g., via NFC communication, Bluetooth, etc.) or over a network (e.g., the Internet).

The acquirer server 106, in turn, is in communication with the transaction processing server 108 via a connection 116. The transaction processing server 108, in turn, is in communication with an issuer server 110 via a connection 118. The connections 116 and 118 may be via a network (e.g., the Internet).

The transaction processing server 108 is further in communication with the action server 140 via a connection 120. The connection 120 may be over a network (e.g., a local area network, a wide area network, the Internet, etc.). In one arrangement, the transaction processing server 108 and the action server 140 are combined and the connection 120 may be an interconnected bus.

The action server 140, in turn, is in communication with the reference database 150 via respective connection 122. The connection 122 may be over a network (e.g., the Internet). The action server 140 may also be connected to a cloud that facilitates the system 100 for reducing a likelihood of a fraudulent transaction. For example, the action server 140 can send a signal or data to the cloud directly via a wireless connection (e.g., via NFC communication, Bluetooth, etc.) or over a network (e.g., the Internet).

The reference database 150 may comprise data that is utilized by the action server 140 for reducing a likelihood of a fraudulent transaction. For example, historical data comprising a previously obtained information relating to the user (e.g., a user profile, a transaction history, a risk profile and a financial profile of the user), a previous determination of whether to allow or block a transaction of the user and a profit earned from the user over the period of time after the previous determination may be stored in the reference database 150. The reference database 150 may also store information relating to a user (e.g., a user profile, a transaction history, a risk profile and a financial profile of the user). In an implementation, the reference database 150 may be combined with the action server 140. In an example, the reference database 150 may be managed by an external entity.

The action server 140 may be configured to estimate a profit that can be earned from a user after each of allowing a transaction of the user and blocking the transaction of the user. The estimated profit may be based on information relating to the user. The action server 140 may then be configured to determine whether the transaction is a fraudulent transaction based on the estimated profit, and allow or block the transaction based on the determination.

In an implementation, determining whether the transaction is a fraudulent transaction may be further based on historical data (e.g., stored in the reference database 150) comprising a previously obtained information relating to the user, a previous determination of whether to allow or block a transaction of the user and a profit earned from the user over the period of time after the previous determination. The determination may be further based on a probability to randomly make a determination to allow or block the transaction. The action server 140 may be further configured to update the historical data based on a profit earned over the period of time after allowing or blocking the transaction. The action server 140 may then be trained based on the updated historical data.

In an implementation, determining whether the transaction is a fraudulent transaction may be further based on maximising the estimated profit that can be earned from the user over the period of time.

In an implementation, estimating the profit that can be earned from the user over the period of time may further comprise defining a vector that is representative of the user based on the information, the information comprising one or more of a user profile, a transaction history, a risk profile and a financial profile of the user, and estimating the value based on the defined vector.

In an implementation, the estimation may further comprise estimating a profit that can be earned from the user over the period of time after blocking a promotion associated with the transaction, wherein determining whether the transaction is a fraudulent transaction is further based on the estimated profit over the period of time after blocking the promotion, and blocking the promotion based on the determination.

In an implementation, the estimation may further comprise estimating a profit that can be earned from the user over the period of time after banning an account of the user, wherein determining whether the transaction is a fraudulent transaction is further based on the estimated profit over the period of time after banning the account of the user; and banning the account of the user based on the determination.

In an implementation, there may be more than one reference databases, in which the action server 140 may be configured to determine which database to use for each step during the process of reducing a likelihood of a fraudulent transaction. Alternatively, one or more modules may store the above-mentioned data instead of the reference database 150, wherein the module may be integrated as part of the action server 140 or external from the action server 140.

In the illustrative embodiment, each of the devices 102, 104, and the servers 106, 108, 110, 140, and/or reference database 150 provides an interface to enable communication with other connected devices 102, 104 and/or servers 106, 108, 110, 140, and/or reference database 150. Such communication is facilitated by an application programming interface (“API”). Such APIs may be part of a user interface that may include graphical user interfaces (GUIs), Web-based interfaces, programmatic interfaces such as application programming interfaces (APIs) and/or sets of remote procedure calls (RPCs) corresponding to interface elements, messaging interfaces in which the interface elements correspond to messages of a communication protocol, and/or suitable combinations thereof. For example, it is possible for the requestor device 102 and/or provider device 104 to send data relating to a transaction, in response to an enquiry shown on the GUI running on the respective API. It is also possible for the requestor device 102 and/or the provider device 104 to send information relating to a user, in response to an enquiry shown on the GUI running on the respective API.

Use of the term ‘server’ herein can mean a single computing device or a plurality of interconnected computing devices which operate together to perform a particular function. That is, the server may be contained within a single hardware unit or be distributed among several or many different hardware units.

The action server 140 is associated with an entity (e.g. a company or organization or moderator of the service). In one arrangement, the action server 140 is owned and operated by the entity operating the transaction processing server 108. In such an arrangement, the action server 140 may be implemented as a part (e.g., a computer program module, a computing device, etc.) of the transaction processing server 108.

The transaction processing server 108 may also be configured to manage the registration of users. A registered user has a transaction account (see the discussion above) which includes details of the user. The registration step is called on-boarding. A user may use either the requestor device 102 or the provider device 104 to perform on-boarding to the transaction processing server 108.

It may not be necessary to have a transaction account at the transaction processing server 108 to access the functionalities of the transaction processing server 108. However, there are functions that are available to a registered user. These additional functions will be discussed below.

The on-boarding process for a user is performed by the user through one of the requestor device 102 or the provider device 104. In one arrangement, the user downloads an app (which includes the API to interact with the transaction processing server 108) to the requestor device 102 or the provider device 104. In another arrangement, the user accesses a website (which includes the API to interact with the transaction processing server 108) on the requestor device 102 or the provider device 104. The user is then able to interact with the action server 140. The user may be a requestor or a provider associated with the requestor device 102 or the provider device 104, respectively.

Details of the registration may include, for example, name of the user, address of the user, birth date, emergency contact, blood type or other healthcare information, next-of-kin contact, permissions to retrieve data and information from the requestor device 102 and/or the provider device 104 for reducing a likelihood of a fraudulent transaction, such as permission to receive data relating to a transaction of the user and information relating to the user (e.g., a user profile, a transaction history, a risk profile and a financial profile of the user) from the requestor device 102 and/or the provider device 104. Alternatively, another mobile device may be selected instead of the requestor device 102 and/or the provider device 104 for retrieving the data. Once on-boarded, the user would have a transaction account that stores all the details.

The requestor device 102 is associated with a customer (or requestor) who is a party to a transaction that occurs between the requestor device 102 and the provider device 104, or between the requestor device 102 and the action server 140. The requestor device 102 may be a computing device such as a desktop computer, an interactive voice response (IVR) system, a smartphone, a laptop computer, a personal digital assistant computer (PDA), a mobile computer, a tablet computer, and the like. The requestor device 102 may be associated with a user who initiates a transaction.

The requestor device 102 includes transaction credentials (e.g., a payment account) of a requestor to enable the requestor device 102 to be a party to a payment transaction. If the requestor has a transaction account, the transaction account may also be included (i.e., stored) in the requestor device 102. For example, a mobile device (which is a requestor device 102) may have the transaction account of the customer stored in the mobile device.

In one example arrangement, the requestor device 102 is a computing device in a watch or similar wearable and is fitted with a wireless communications interface (e.g., a NFC interface). The requestor device 102 can then electronically communicate with the provider device 104 regarding a transaction request. The customer uses the watch or similar wearable to make a transaction request by pressing a button on the watch or wearable.

The provider device 104 is associated with a provider who is also a party to the transaction request that occurs between the requestor device 102 and the provider device 104. The provider device 104 may be a computing device such as a desktop computer, an interactive voice response (IVR) system, a smartphone, a laptop computer, a personal digital assistant computer (PDA), a mobile computer, a tablet computer, and the like. The provider device 104 may be associated with an initiator or provider of a transaction (e.g., a driver or deliverer responding to the request for the ride or delivery).

Hereinafter, the term “provider” refers to a service provider and any third party associated with providing a product or service for purchase, or a travel or ride or delivery service via the provider device 104. Therefore, the transaction account of a provider refers to both the transaction account of a provider and the transaction account of a third party (e.g., a travel co-ordinator or merchant) associated with the provider. It will be appreciated that the provider device 104 may also be used by a user for making a transaction.

If the provider has a transaction account, the transaction account may also be included (i.e., stored) in the provider device 104. For example, a mobile device (which is a provider device 104) may have the transaction account of the provider stored in the mobile device.

In one example arrangement, the provider device 104 is a computing device in a watch or similar wearable and is fitted with a wireless communications interface (e.g., a NFC interface). The provider device 104 can then electronically communicate with the requestor to make or respond to a transaction request by pressing a button on the watch or wearable.

The acquirer server 106 is associated with an acquirer who may be an entity (e.g. a company or organization) which issues (e.g. establishes, manages, administers) a payment account (e.g. a financial bank account) of a merchant. Examples of the acquirer include a bank and/or other financial institution. As discussed above, the acquirer server 106 may include one or more computing devices that are used to establish communication with another server (e.g., the transaction processing server 108) by exchanging messages with and/or passing information to the other server. The acquirer server 106 forwards the payment transaction relating to a transaction request to the transaction processing server 108.

The transaction processing server 108 is configured to process processes relating to a transaction account by, for example, forwarding data and information associated with the transaction to the other servers in the system 100 such as the action server 140. In an example, the transaction processing server 108 may, instead of the requestor device 102 or provider device 104, transmit data relating to a transaction of a user (e.g., date, time, details of good or service to be purchased, and other similar data) to the action server 140. The transaction processing server 108 may use a variety of different protocols and procedures in order to process the transaction. It will be appreciated that payment for a transaction may be made via a variety of methods such as credit cards, debit cards, digital wallets, buy-first pay-later schemes, and other similar payment methods.

The issuer server 110 is associated with an issuer and may include one or more computing devices that are used to perform a payment transaction. The issuer may be an entity (e.g. a company or organization) which issues (e.g. establishes, manages, administers) a transaction credential or a payment account (e.g. a financial bank account) associated with the owner of the requestor device 102. As discussed above, the issuer server 110 may include one or more computing devices that are used to establish communication with another server (e.g., the transaction processing server 108) by exchanging messages with and/or passing information to the other server.

The reference database 150 is a database or server associated with an entity (e.g. a company or organization) which manages (e.g. establishes, administers) data relating to users, transactions, products, services, and other similar data, for example relating to the entity. In an arrangement, the reference database 150 may comprise data that is utilized by the action server 140 for reducing a likelihood of a fraudulent transaction. For example, historical data comprising a previously obtained information relating to a user (e.g., a user profile, a transaction history, a risk profile, a financial profile, and other similar information relating to the user), a previous determination of whether to allow or block a transaction of the user and a profit earned from the user over the period of time after the previous determination may be stored in the reference database 150. The reference database 150 may also store information relating to a user (e.g., a user profile, a transaction history, a risk profile and a financial profile of the user). In an implementation, the reference database 150 may be combined with the action server 140. In an example, the reference database 150 may be managed by an external entity.

Advantageously, the system 100 advantageously enables a fraud protection system that adapts to changes in the environment through exploration of actions to take, and utilizes quantitatively measurable metrics (e.g., profit over a specific period of time) to reinforce its decisions.

FIG. 2 illustrates a schematic diagram of an example action server 140 according to various embodiments. The action server 140 may comprise a data module 260 configured to receive data and information from the requestor device 102, provider device 104, transaction processing server 108, reference database 150, a cloud and other sources of information to reduce a likelihood of a fraudulent transaction by the action server 140. For example, the data module 260 may be configured to receive historical data and information relating to a user, as well as data and information required for processing the historical data and information relating to the user, estimating a profit that can be earned over a period of time after an action (e.g., estimating a profit that can be earned over a period of time after each of allowing a transaction of the user, blocking the transaction, blocking a promotion associated with the transaction, banning an account of the user, of other similar actions), determining whether the transaction is a fraudulent transaction based on the estimated profit, and other similar processes from the requestor device 102, the provider device 104, transaction processing server 108, reference database 150, and/or other sources of information. The data module 260 may be further configured to send information relating to a determination of whether the transaction is a fraudulent transaction to the requestor device 102, the provider device 104, the transaction processing server 108, or other destinations where the information is required.

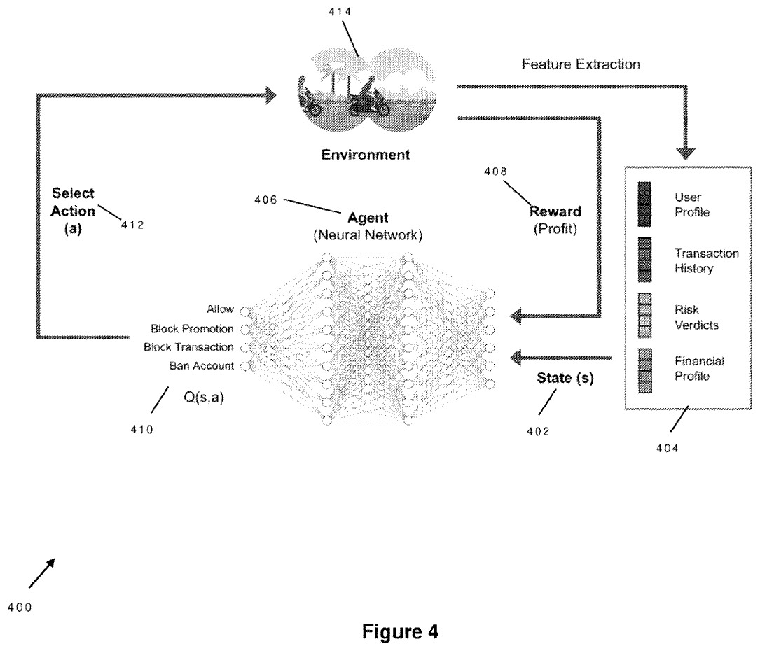

The action server 140 may comprise a state module 262 that is configured for defining a vector that is representative of a state of the user based on the information relating to the user, the information comprising one or more of a user profile, a transaction history, a risk profile, a financial profile of the user, and other similar information relating to the user. The vector defining process is further explained in FIG. 4.

The action server 140 may also comprise an estimation module 264 that is configured for estimating a profit that can be earned from a user over a period of time after each of allowing a transaction of the user and blocking the transaction of the user, the estimated profit being based on information relating to the user. The estimation process is further explained in FIG. 4.

The action server 140 may also comprise an action module 266 that is configured for determining whether the transaction is a fraudulent transaction based on the estimated profit. The action module 266 may be further configured for allowing or blocking the transaction based on the determination. The determination process is further explained in FIG. 4.

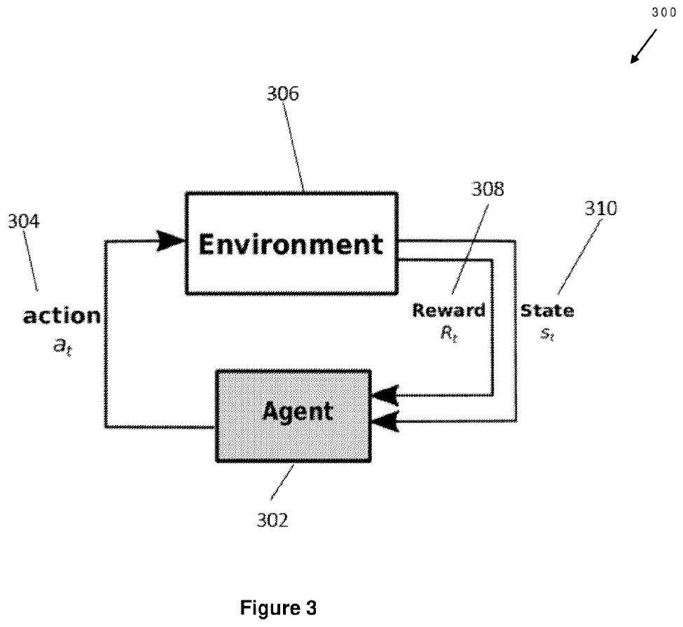

The action server 140 may also comprise a training module 268 that is configured for updating the historical data based on a profit earned over the period of time after allowing or blocking the transaction. The training module 268 may be further configured for training the action server 140 based on the updated historical data. The training process is further explained in FIG. 3.

In an implementation, determining whether the transaction is a fraudulent transaction may be further based on historical data (e.g., stored in the reference database 150) comprising a previously obtained information relating to the user, a previous determination of whether to allow or block a transaction of the user and a profit earned from the user over the period of time after the previous determination. The determination may be further based on a probability to randomly make a determination to allow or block the transaction.

In an implementation, determining whether the transaction is a fraudulent transaction may be further based on maximising the estimated profit that can be earned from the user over the period of time.

In an implementation, estimating the profit that can be earned from the user over the period of time may further comprise defining a vector that is representative of the user based on the information, the information comprising one or more of a user profile, a transaction history, a risk profile and a financial profile of the user, and estimating the value based on the defined vector.

In an implementation, the estimation may further comprise estimating a profit that can be earned from the user over the period of time after blocking a promotion associated with the transaction, wherein determining whether the transaction is a fraudulent transaction is further based on the estimated profit over the period of time after blocking the promotion, and blocking the promotion based on the determination.

In an implementation, the estimation may further comprise estimating a profit that can be earned from the user over the period of time after banning an account of the user, wherein determining whether the transaction is a fraudulent transaction is further based on the estimated profit over the period of time after banning the account of the user; and banning the account of the user based on the determination.

Each of the data module 260, state module 262, estimation module 264, action module 266 and training module 268 may further be in communication with a processing module (not shown) of the action server 140, for example for coordination of respective tasks and functions during the process. The data module 260 may be further configured to communicate with and store data and information for each of the processing module, state module 262, estimation module 264, action module 266 and training module 268. Alternatively, all the tasks and functions required for adaptively reducing a likelihood of a fraudulent transaction may be performed by a single processor of the action server 140.

FIG. 3 depicts an overview 300 of Reinforcement Learning (RL) according to various embodiments. A typical framing of a RL scenario is as follows: an agent 302 takes an action 304 in an environment 306, which is interpreted into a reward 308 and a representation of the state 310, which are fed back into the agent 302. The environment 306 is where a user reacts to the action 304 taken by the agent 304 in real life. In an example, the user may choose to continue making further transactions on the platform, which may generate positive or negative reward/profit depending on a promotion that may be used with a transaction of the user prior to the action 304. In another example, the user may choose to no longer use the platform, resulting in zero reward/profit. In another example, the user may conduct fraud, resulting in negative profit to the platform. The agent 302 thus learns to make decisions on what action to take for each user state (e.g., state of the user, or user feature) based on the objective to maximise such observed reward/profit from the user in the long run.

FIG. 4 depicts an example illustration 400 of how an action to take in response to a transaction request may be determined according to various embodiments. The illustration 400 may also be termed as a DRL fraud prevention system 400, in which a determination of whether a transaction is a fraudulent transaction is made by the system 400.

The steps to implement this system 400 is as follows. Firstly, a state 402 is defined. The state 402 is composed of information related to a user (e.g., the user associated with a transaction), including but not limited to a list of features 404 such as a user profile, transaction history, risk verdicts, financial profile and other similar features relating to the user. It is a vector representation of the user upon fraud check, and may be termed as a vector 402. A user profile may refer to details of a user such as country, city, platform, device information, a predicted gender of the user (e.g., obtained from other ML models) if not registered with the platform (e.g., during on-boarding registration with the transaction processing server 108), a predicted age of the user (e.g., obtained from other ML models) if not registered with the platform (e.g., during on-boarding registration with the transaction processing server 108), and other similar details. Risk verdicts may refer to a risk level (e.g., determined by the platform based on transaction history and past activities of a user) that the user poses to the platform. A financial profile of a user may refer to information relating to, for example, one or more credit or debit accounts, and statuses of each account of the user.

Secondly, an agent 406 is defined. In an implementation, the agent 406 is a Deep Neural Network that takes the vector 402 as input and outputs an estimated value (e.g., an expected future reward such as an estimated profit that can be earned from a user over a period of time, such as a next X days (X is a tunable parameter)) of each action (from the fraud prevention system 400) for a user state represented by the vector 402. For example, if an estimated profit is negative as a result of allowing a transaction (e.g., indicating a loss to the company as a result of allowing the transaction), the transaction may be determined as a fraudulent transaction.

Thirdly, the agent 406 may be trained. Historical data (e.g., historical data relating to the platform's existing fraud prevention system rules, such as comprising a previously obtained information relating to the user, a previous determination of whether to allow or block a transaction of the user and a profit earned from the user over the period of time after the previous determination) is retrieved for training, allowing the agent 406 to mimic its decisions to ensure a good baseline performance. The data may be formatted as [state, action, reward], wherein the reward may be a profit that is earned from the user for a period of time such as a next X days (X is a tunable parameter) post fraud checking and actioning.

Fourthly, the system 400 is deployed. The system 400 may be configured to use an epsilon-greedy action selection online, where it explores the unknown in an environment 414 by randomly choosing an action 412 from a plurality of actions 410 (e.g., allowing the transaction request, blocking the transaction request, blocking a promotion associated with the transaction request, banning an account of the user, or other similar actions) based on an epsilon probability and learning from the observed reward (e.g., an obtained value 408 as a result of the action 412, for example a profit earned from the user over a period of time after the action 412). This advantageously allows the agent 406 to improve its knowledge about the environment and adapt to the changes, which leads to better reward in the long run. Other times, it exploits by choosing an action that has the maximum estimated reward, which is essentially maximizing the profit.

In a first example, during a fraud check, the agent 406 may estimate that allowing a transaction brings negative profit and blocking the transaction brings positive profit. Based on this estimation, the system 400 may be configured to determine that this is a fraudulent transaction. With a high probability for exploitation (e.g., to maximise profit), the agent 406 may take a ‘greedy’ action (e.g., an action that maximises profit) by blocking this transaction. In a second example, the agent 406 may estimate that allowing the transaction brings positive profit and blocking the transaction brings negative profit. Based on this estimation, the system 400 may be configured to determine that this is not a fraudulent transaction. With a high probability for exploitation (e.g., to maximise profit), the agent 406 may thus allow the transaction to proceed. In both cases, there may be a small probability of 1-epsilon to explore (e.g., a probability to randomly make a determination to allow or block the transaction, or to take an action that is different from a ‘correct action’ (e.g., ‘correct action’ being blocking the transaction in the first example and allowing the transaction in the second example)) such that the system 400 can learn from the outcome of the action that is taken by the agent 406.

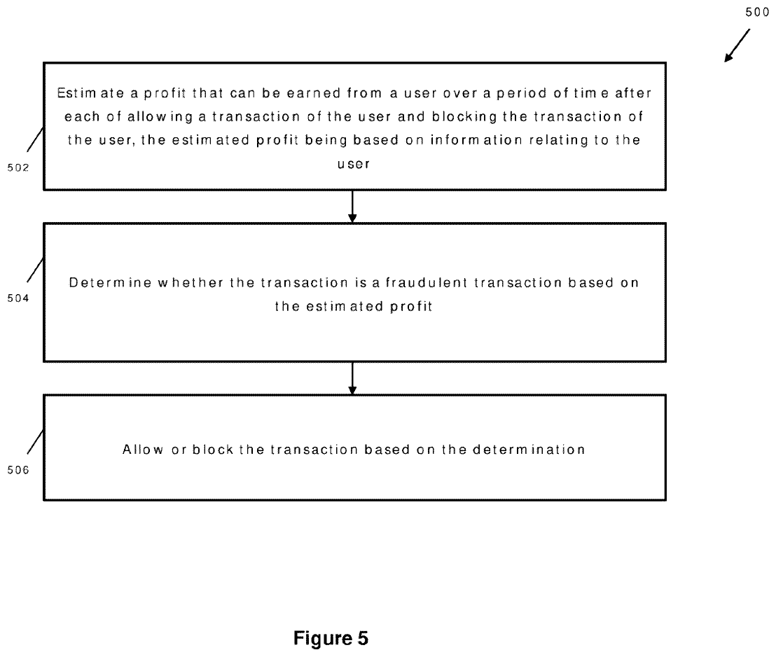

FIG. 5 illustrates an example flow diagram of a method 500 for reducing a likelihood of a fraudulent transaction according to various embodiments. In a step 502, a profit that can be earned from a user over a period of time after each of allowing a transaction of the user and blocking the transaction of the user is estimated, the estimated profit being based on information relating to the user. In a step 504, it is determined whether the transaction is a fraudulent transaction based on the estimated profit. In a step 506, the transaction is allowed or blocked based on the determination.

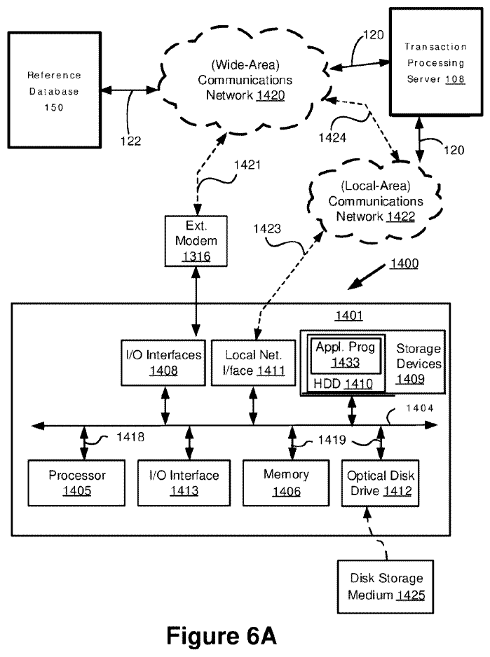

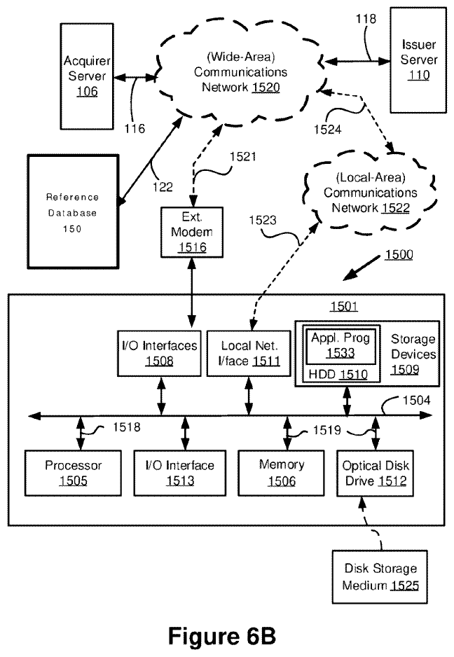

FIG. 6A depicts an example computer system 1400, in accordance with which the action server 140 described can be practiced. The computer system 1400 includes a computer module 1401. An external Modulator-Demodulator (Modem) transceiver device 1416 may be used by the computer module 1401 for communicating to and from a communications network 1420 via a connection 1421. The communications network 1420 may be a wide-area network (WAN), such as the Internet, a cellular telecommunications network, or a private WAN. Where the connection 1421 is a telephone line, the modem 1416 may be a traditional “dial-up” modem. Alternatively, where the connection 1421 is a high capacity (e.g., cable) connection, the modem 1416 may be a broadband modem. A wireless modem may also be used for wireless connection to the communications network 1420.

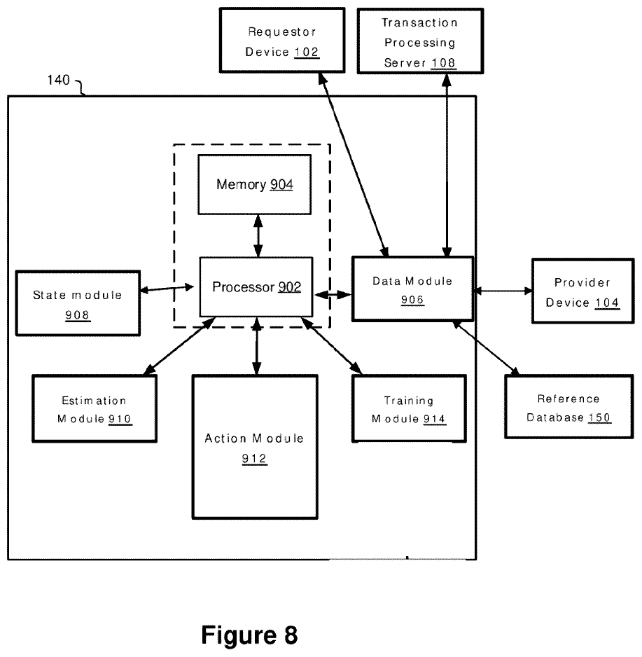

The computer module 1401 typically includes at least one processor unit 1405, and a memory unit 1406. For example, the memory unit 1406 may have semiconductor random access memory (RAM) and semiconductor read only memory (ROM). The computer module 1401 also includes an interface 1408 for the external modem 1416. In some implementations, the modem 1416 may be incorporated within the computer module 1401, for example within the interface 1408. The computer module 1401 also has a local network interface 1411, which permits coupling of the computer system 1400 via a connection 1423 to a local-area communications network 1422, known as a Local Area Network (LAN). As illustrated in FIG. 8A, the local communications network 1422 may also couple to the wide network 1420 via a connection 1424, which would typically include a so-called “firewall” device or device of similar functionality. The local network interface 1411 may comprise an Ethernet circuit card, a Bluetooth® wireless arrangement or an IEEE 802.11 wireless arrangement; however, numerous other types of interfaces may be practiced for the interface 1411.

The I/O interfaces 1408 may afford either or both of serial and parallel connectivity, the former typically being implemented according to the Universal Serial Bus (USB) standards and having corresponding USB connectors (not illustrated). Storage devices 1409 are provided and typically include a hard disk drive (HDD) 1410. Other storage devices such as a floppy disk drive and a magnetic tape drive (not illustrated) may also be used. An optical disk drive 1412 is typically provided to act as a non-volatile source of data. Portable memory devices, such optical disks, USB-RAM, portable, external hard drives, and floppy disks, for example, may be used as appropriate sources of data to the system 1400.

The components 1405 to 1412 of the computer module 1401 typically communicate via an interconnected bus 1304 and in a manner that results in a conventional mode of operation of the computer system 1400 known to those in the relevant art. For example, the processor 1405 is coupled to the system bus 1404 using a connection 1418. Likewise, the memory 1406 and optical disk drive 1412 are coupled to the system bus 1404 by connections 1419. Examples of computers on which the described arrangements can be practised include IBM-PC's and compatibles, Sun Sparcstations, Apple or like computer systems.

The method 500, where performed by the action server 140 may be implemented using the computer system 1400. The processes may be implemented as one or more software application programs 1433 executable within the computer system 1400. In particular, the method 500 is effected by instructions in the software 1433 that are carried out within the computer system 1400. The software instructions may be formed as one or more code modules, each for performing one or more particular tasks. The software may also be divided into two separate parts, in which a first part and the corresponding code modules performs the method 500 and a second part and the corresponding code modules manage a user interface between the first part and the user.

The software may be stored in a computer readable medium, including the storage devices described below, for example. The software is loaded into the computer system 1400 from the computer readable medium, and then executed by the computer system 1400. A computer readable medium having such software or computer program recorded on the computer readable medium is a computer program product. The use of the computer program product in the computer system 1400 preferably effects an advantageous apparatus for an action server 140.

The software 1433 is typically stored in the HDD 1410 or the memory 1406. The software is loaded into the computer system 1400 from a computer readable medium, and executed by the computer system 1400. Thus, for example, the software 1433 may be stored on an optically readable disk storage medium (e.g., CD-ROM) 1425 that is read by the optical disk drive 1412. A computer readable medium having such software or computer program recorded on it is a computer program product. The use of the computer program product in the computer system 1400 preferably effects an apparatus for an action server 140.

In some instances, the application programs 1433 may be supplied to the user encoded on one or more CD-ROMs 1425 and read via the corresponding drive 1412, or alternatively may be read by the user from the networks 1420 or 1422. Still further, the software can also be loaded into the computer system 1400 from other computer readable media. Computer readable storage media refers to any non-transitory tangible storage medium that provides recorded instructions and/or data to the computer system 1400 for execution and/or processing. Examples of such storage media include floppy disks, magnetic tape, optical disc, a hard disk drive, a ROM or integrated circuit, USB memory, a magneto-optical disk, or a computer readable card such as a PCMCIA card and the like, whether or not such devices are internal or external of the computer module 1401. Examples of transitory or non-tangible computer readable transmission media that may also participate in the provision of software, application programs, instructions and/or data to the computer module 1401 include radio or infra-red transmission channels as well as a network connection to another computer or networked device, and the Internet or Intranets including e-mail transmissions and information recorded on Websites and the like.

The second part of the application programs 1433 and the corresponding code modules mentioned above may be executed to implement one or more graphical user interfaces (GUIs) to be rendered or otherwise represented upon a display. Through manipulation of typically a keyboard and a mouse, a user of the computer system 1400 and the application may manipulate the interface in a functionally adaptable manner to provide controlling commands and/or input to the applications associated with the GUI(s). Other forms of functionally adaptable user interfaces may also be implemented, such as an audio interface utilizing speech prompts output via loudspeakers and user voice commands input via a microphone.

It is to be understood that the structural context of the computer system 1400 (i.e., the action server 140) is presented merely by way of example. Therefore, in some arrangements, one or more features of the computer system 1400 may be omitted. Also, in some arrangements, one or more features of the computer system 1400 may be combined together. Additionally, in some arrangements, one or more features of the computer system 1400 may be split into one or more component parts.

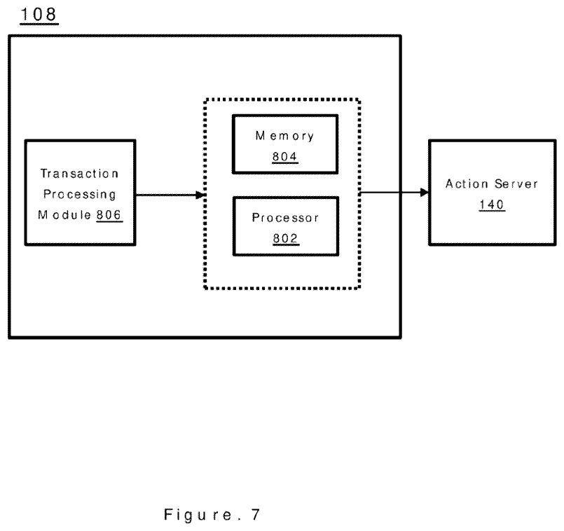

FIG. 7 shows an implementation of the transaction processing server 108. In this implementation, the transaction processing 108 may be generally described as a physical device comprising at least one processor 802 and at least one memory 804 including computer program codes. The at least one memory 804 and the computer program codes are configured to, with the at least one processor 802, cause the transaction processing server 108 to facilitate the operations described in method 500. The transaction processing server 108 may also include a transaction processing module 806. The memory 804 stores computer program code that the processor 802 compiles to have transaction processing module 806 perform the respective functions.

With reference to FIG. 1, the transaction processing module 806 performs the function of communicating with the requestor device 102 and the provider device 104; and the acquirer server 106 and the issuer server 110 to respectively receive and transmit a transaction, a request for a ride or delivery, or other similar messages. The transaction processing module 806 may be configured to process processes relating to a transaction account by, for example, forwarding data and information associated with the transaction to the other servers in the system 100 such as the action server 140. For example, data relating to a transaction of a user (e.g., date, time, details of good or service to be purchased, and other similar data), information relating to the user (e.g., a user profile, a transaction history, a risk profile, a financial profile and other similar information relating to the user), and other similar data may be provided to the action server 140 and processed to determine an action to take on the user. The transaction processing server 806 may use a variety of different protocols and procedures in order to process the payment and/or travel co-ordination requests.

FIG. 8 shows an alternative implementation of the action server 140 (i.e., the computer system 1400). In the alternative implementation, action server 140 may be generally described as a physical device comprising at least one processor 902 and at least one memory 904 including computer program codes. The at least one memory 904 and the computer program codes are configured to, with the at least one processor 902, cause the action server 140 to perform the operations described in the method 500. The action server 140 may also include a data module 906, a state module 908, an estimation module 910, an action module 912 and a training module 914. The memory 904 stores computer program code that the processor 902 compiles to have each of the modules 906 to 914 performs their respective functions.

With reference to FIGS. 1 to 5, the state module 908 performs the function of defining a vector that is representative of a state of the user based on the information relating to the user, the information comprising one or more of a user profile, a transaction history, a risk profile, a financial profile of the user, and other similar information relating to the user.

With reference to FIGS. 1 to 5, the estimation module 910 performs the function of estimating a profit that can be earned from a user over a period of time after each of allowing a transaction of the user and blocking the transaction of the user, the estimated profit being based on information relating to the user.

With reference to FIGS. 1 to 5, the action module 912 performs the function of determining whether the transaction is a fraudulent transaction based on the estimated profit. The action module 912 may be further configured for allowing or blocking the transaction based on the determination.

With reference to FIGS. 1 to 5, the training module 914 performs the function of updating the historical data based on a profit earned over the period of time after allowing or blocking the transaction. The training module 914 may be further configured for training the action server 140 based on the updated historical data.

In an implementation, determining whether the transaction is a fraudulent transaction may be further based on historical data (e.g., stored in the reference database 150) comprising a previously obtained information relating to the user, a previous determination of whether to allow or block a transaction of the user and a profit earned from the user over the period of time after the previous determination. The determination may be further based on a probability to randomly make a determination to allow or block the transaction.

In an implementation, determining whether the transaction is a fraudulent transaction may be further based on maximising the estimated profit that can be earned from the user over the period of time.

In an implementation, estimating the profit that can be earned from the user over the period of time may further comprise defining a vector that is representative of the user based on the information, the information comprising one or more of a user profile, a transaction history, a risk profile and a financial profile of the user, and estimating the value based on the defined vector.

In an implementation, the estimation may further comprise estimating a profit that can be earned from the user over the period of time after blocking a promotion associated with the transaction, wherein determining whether the transaction is a fraudulent transaction is further based on the estimated profit over the period of time after blocking the promotion, and blocking the promotion based on the determination.

In an implementation, the estimation may further comprise estimating a profit that can be earned from the user over the period of time after banning an account of the user, wherein determining whether the transaction is a fraudulent transaction is further based on the estimated profit over the period of time after banning the account of the user; and banning the account of the user based on the determination.

With reference to FIGS. 1 to 5, the data module 906 performs the functions of receiving data and information from the requestor device 102, provider device 104, transaction processing server 108, reference database 150, a cloud and other sources of information to facilitate the method 500. For example, the data module 906 may be configured to receive historical data and information relating to a user, as well as data and information required for processing the historical data and information relating to the user, estimating a profit that can be earned over a period of time after an action (e.g., estimating a profit that can be earned over a period of time after each of allowing a transaction of the user, blocking the transaction, blocking a promotion associated with the transaction, banning an account of the user, of other similar actions), determining whether the transaction is a fraudulent transaction based on the estimated profit, and other similar processes from the requestor device 102, the provider device 104, transaction processing server 108, reference database 150, and/or other sources of information. The data module 906 may be further configured to send information relating to a determination of whether the transaction is a fraudulent transaction to the requestor device 102, the provider device 104, the transaction processing server 108, or other destinations where the information is required.

FIG. 6B depicts a general-purpose computer system 1500, upon which a combined transaction processing server 108 and action server 140 described can be practiced. The computer system 1500 includes a computer module 1501. An external Modulator-Demodulator (Modem) transceiver device 1516 may be used by the computer module 1501 for communicating to and from a communications network 1520 via a connection 1521. The communications network 1520 may be a wide-area network (WAN), such as the Internet, a cellular telecommunications network, or a private WAN. Where the connection 1521 is a telephone line, the modem 1516 may be a traditional “dial-up” modem. Alternatively, where the connection 1521 is a high capacity (e.g., cable) connection, the modem 1516 may be a broadband modem. A wireless modem may also be used for wireless connection to the communications network 1520.

The computer module 1501 typically includes at least one processor unit 1505, and a memory unit 1506. For example, the memory unit 1506 may have semiconductor random access memory (RAM) and semiconductor read only memory (ROM). The computer module 1501 also includes an interface 1508 for the external modem 1516. In some implementations, the modem 1516 may be incorporated within the computer module 1501, for example within the interface 1508. The computer module 1501 also has a local network interface 1511, which permits coupling of the computer system 1500 via a connection 1523 to a local-area communications network 1522, known as a Local Area Network (LAN). As illustrated in FIG. 8D, the local communications network 1522 may also couple to the wide network 1520 via a connection 1524, which would typically include a so-called “firewall” device or device of similar functionality. The local network interface 1511 may comprise an Ethernet circuit card, a Bluetooth® wireless arrangement or an IEEE 802.11 wireless arrangement; however, numerous other types of interfaces may be practiced for the interface 1511.

The I/O interfaces 1508 may afford either or both of serial and parallel connectivity, the former typically being implemented according to the Universal Serial Bus (USB) standards and having corresponding USB connectors (not illustrated). Storage devices 1509 are provided and typically include a hard disk drive (HDD) 1510. Other storage devices such as a floppy disk drive and a magnetic tape drive (not illustrated) may also be used. An optical disk drive 1512 is typically provided to act as a non-volatile source of data. Portable memory devices, such optical disks, USB-RAM, portable, external hard drives, and floppy disks, for example, may be used as appropriate sources of data to the system 1500.

The components 1505 to 1512 of the computer module 1501 typically communicate via an interconnected bus 1504 and in a manner that results in a conventional mode of operation of the computer system 1500 known to those in the relevant art. For example, the processor 1505 is coupled to the system bus 1504 using a connection 1518. Likewise, the memory 1506 and optical disk drive 1512 are coupled to the system bus 1504 by connections 1519. Examples of computers on which the described arrangements can be practised include IBM-PC's and compatibles, Sun Sparcstations, Apple or like computer systems.

The steps of the method 500 performed by the action server 140 and facilitated by the transaction processing server 108 may be implemented using the computer system 1500. For example, the steps of the method 500 as performed by the action server 140 may be implemented as one or more software application programs 1533 executable within the computer system 1500. In particular, the steps of the method 500 are effected by instructions in the software 1533 that are carried out within the computer system 1500. The software instructions may be formed as one or more code modules, each for performing one or more particular tasks. The software may also be divided into two separate parts, in which a first part and the corresponding code modules performs the steps of the method 500 and a second part and the corresponding code modules manage a user interface between the first part and the user.

The software may be stored in a computer readable medium, including the storage devices described below, for example. The software is loaded into the computer system 1500 from the computer readable medium, and then executed by the computer system 1500. A computer readable medium having such software or computer program recorded on the computer readable medium is a computer program product. The use of the computer program product in the computer system 1500 preferably effects an advantageous apparatus for a combined transaction processing and action server.

The software 1533 is typically stored in the HDD 1510 or the memory 1506. The software is loaded into the computer system 1500 from a computer readable medium, and executed by the computer system 1500. Thus, for example, the software 1533 may be stored on an optically readable disk storage medium (e.g., CD-ROM) 1525 that is read by the optical disk drive 1512. A computer readable medium having such software or computer program recorded on it is a computer program product. The use of the computer program product in the computer system 1500 preferably effects an apparatus for a combined transaction processing and action server.

In some instances, the application programs 1533 may be supplied to the user encoded on one or more CD-ROMs 1525 and read via the corresponding drive 1512, or alternatively may be read by the user from the networks 1520 or 1522. Still further, the software can also be loaded into the computer system 1500 from other computer readable media. Computer readable storage media refers to any non-transitory tangible storage medium that provides recorded instructions and/or data to the computer system 1500 for execution and/or processing. Examples of such storage media include floppy disks, magnetic tape, optical disc, a hard disk drive, a ROM or integrated circuit, USB memory, a magneto-optical disk, or a computer readable card such as a PCMCIA card and the like, whether or not such devices are internal or external of the computer module 1501. Examples of transitory or non-tangible computer readable transmission media that may also participate in the provision of software, application programs, instructions and/or data to the computer module 1501 include radio or infra-red transmission channels as well as a network connection to another computer or networked device, and the Internet or Intranets including e-mail transmissions and information recorded on Websites and the like.

The second part of the application programs 1533 and the corresponding code modules mentioned above may be executed to implement one or more graphical user interfaces (GUIs) to be rendered or otherwise represented upon a display. Through manipulation of typically a keyboard and a mouse, a user of the computer system 1500 and the application may manipulate the interface in a functionally adaptable manner to provide controlling commands and/or input to the applications associated with the GUI(s). Other forms of functionally adaptable user interfaces may also be implemented, such as an audio interface utilizing speech prompts output via loudspeakers and user voice commands input via a microphone.

It is to be understood that the structural context of the computer system 1500 (i.e., combined transaction processing and action server 1500) is presented merely by way of example. Therefore, in some arrangements, one or more features of the server 1500 may be omitted. Also, in some arrangements, one or more features of the server 1500 may be combined together. Additionally, in some arrangements, one or more features of the server 1500 may be split into one or more component parts.

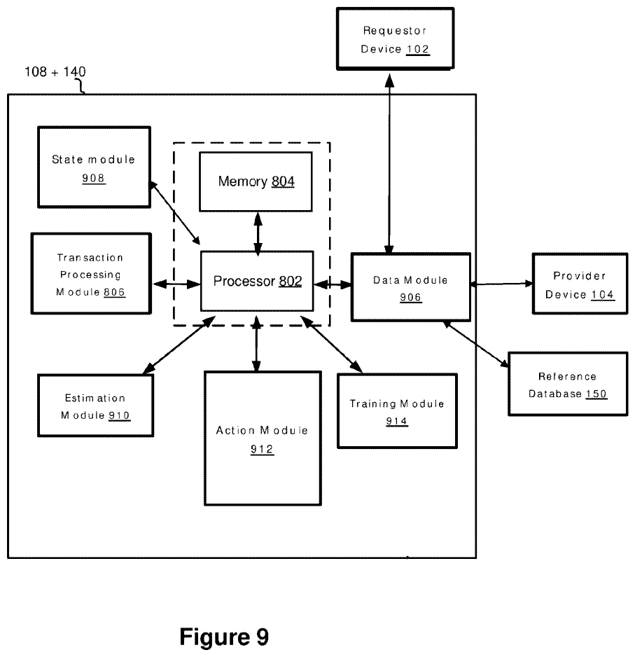

FIG. 9 shows an alternative implementation of combined transaction processing and action server (i.e., the computer system 1500). In the alternative implementation, the combined transaction processing and action server may be generally described as a physical device comprising at least one processor 1002 and at least one memory 904 including computer program codes. The at least one memory 1004 and the computer program codes are configured to, with the at least one processor 1002, cause the combined transaction processing and action server to perform the operations described in the steps of the method 500. The combined transaction processing and action server may also include a transaction processing module 806, a data module 906, a state module 908, an estimation module 910, an action module 912 and a training module 914. The memory 1004 stores computer program code that the processor 1002 compiles to have each of the modules 806 to 912 performs their respective functions. The transaction processing module 806 performs the same functions as described for the same transaction processing module in FIG. 9. The data module 906, state module 908, estimation module 910, action module 912 and training module 914 perform the same functions as described for the same corresponding modules in FIG. 8.

It will be appreciated by a person skilled in the art that numerous variations and/or modifications may be made to the present disclosure as shown in the specific embodiments without departing from the scope of the specification as broadly described. The present embodiments are, therefore, to be considered in all respects to be illustrative and not restrictive.

What is claimed is:

1. A method for reducing a likelihood of a fraudulent transaction, comprising:
estimating, by a server, a profit that can be earned from a user over a period of time after each of allowing a transaction of the user and blocking the transaction of the user, the estimated profit being based on information relating to the user;
determining, by the server, whether the transaction is a fraudulent transaction based on the estimated profit, and allowing or blocking the transaction based on the determination.

2. The method of claim 1, wherein determining whether the transaction is a fraudulent transaction is further based on historical data comprising a previously obtained information relating to the user, a previous determination of whether to allow or block a transaction of the user and a profit earned from the user over the period of time after the previous determination.

3. The method of claim 2, wherein determining whether the transaction is a fraudulent transaction is further based on a probability to randomly make a determination to allow or block the transaction.

4. The method of claim 1, wherein determining whether the transaction is a fraudulent transaction is further based on maximising the estimated profit earned from the user over the period of time.

5. The method of claim 1, wherein estimating the profit that can be earned from the user over the period of time further comprises defining a vector that is representative of the user based on the information, the information comprising one or more of a user profile, a transaction history, a risk profile and a financial profile of the user, and estimating the value based on the defined vector.

6. The method of claim 1, wherein estimating the profit that can be earned from the user over the period of time further comprises:
estimating a profit that can be earned from the user over the period of time after blocking a promotion associated with the transaction, wherein determining whether the transaction is a fraudulent transaction is further based on the estimated profit over the period of time after blocking the promotion; and
blocking the promotion based on the determination.

7. The method of claim 1, wherein estimating the profit that can be earned from the user over the period of time further comprises:
estimating a profit that can be earned from the user over the period of time after banning an account of the user, wherein determining whether the transaction is a fraudulent transaction is further based on the estimated profit over the period of time after banning the account of the user; and
banning the account of the user based on the determination.

8. The method of claim 2, further comprising updating the historical data based on a profit earned over the period of time after allowing or blocking the transaction; and training the server based on the updated historical data.

9. A system for reducing a likelihood of a fraudulent transaction, comprising:
at least one processor; and at least one memory including computer program code; the at least one memory and the computer program code configured to, with the at least one processor, cause the system at least to:
estimate a profit that can be earned from a user over a period of time after each of allowing a transaction of the user and blocking the transaction of the user, the estimated profit being based on information relating to the user;
determine whether the transaction is a fraudulent transaction based on the estimated profit, and allowing or blocking the transaction based on the determination.

10. The system of claim 9, wherein determining whether the transaction is a fraudulent transaction is further based on historical data comprising a previously obtained information relating to the user, a previous determination of whether to allow or block a transaction of the user and a profit earned from the user over the period of time after the previous determination.

11. The system of claim 10, wherein determining whether the transaction is a fraudulent transaction is further based on a probability to randomly make a determination to allow or block the transaction.

12. The system of claim 9, wherein determining whether the transaction is a fraudulent transaction is further based on maximising the estimated profit earned from the user over the period of time.

13. The system of claim 9, wherein estimating the profit that can be earned from the user over the period of time further comprises defining a vector that is representative of the user based on the information, the information comprising one or more of a user profile, a transaction history, a risk profile and a financial profile of the user, and estimating the value based on the defined vector.

14. The system of claim 8, wherein estimating the profit that can be earned from the user over the period of time further comprises:
estimating a profit that can be earned from the user over the period of time after blocking a promotion associated with the transaction, wherein determining whether the transaction is a fraudulent transaction is further based on the estimated profit over the period of time after blocking the promotion; and
blocking the promotion based on the determination.

15. The system of claim 9, wherein estimating the profit that can be earned from the user over the period of time further comprises:
estimating a profit that can be earned from the user over the period of time after banning an account of the user, wherein determining whether the transaction is a fraudulent transaction is further based on the estimated profit over the period of time after banning the account of the user; and
banning the account of the user based on the determination.

16. The system of claim 10, further configured to update the historical data based on a profit earned over the period of time after allowing or blocking the transaction; and training the server based on the updated historical data.
